(19) United States
(12) Patent Application Publication
(10) Pub. No.: US 2023/0296751 A1
(43) Pub. Date: Sep. 21, 2023

(54) Electronic Devices with Leakage Cancellation for Range Detection

(71) Applicant: Apple Inc., Cupertino, CA (US)

(72) Inventors: Mark G. Forbes, San Carlos, CA (US); Ran Forte, Bnei Dror (IL); Michael Delishansky, Netanya (IL); Michael Kerner, Tel Mond (IL); Bernhard Sogl, Unterhaching (DE); Jochen Schrattenecker, Alberndorf in der Riedmark (AT)

(21) Appl. No.: 18/068,990

(22) Filed: Dec. 20, 2022

Related U.S. Application Data
(60) Provisional application No. 63/321,047, filed on Mar. 17, 2022.

(51) Int. Cl. G01S 13/36; G01S 7/35; H01Q 3/36

(52) U.S. Cl. CPC G01S 13/36; G01S 7/354; H01Q 3/36; G01S 7/356

(57) ABSTRACT

An electronic device may include wireless circuitry with a transmit antenna and a receive antenna. Signal bursts may be transmitted by the transmit antenna. A phase shifter may be toggled between a first state that applies a first phase shift and a second state that applies a second phase shift to the signal bursts. The second phase shift may be approximately 180 degrees out-of-phase with the first phase shift. A receive path may receive first reflected signals while the phase shifter is in the first state and second reflected signals while in the second state. The first and second reflected signals may be used to cancel the effects of on-chip leakage or DC offset to recover a signal-of-interest associated with reflection of the signal bursts off an external object. The signal-of-interest may be used to detect a range to the external object.

This application claims the benefit of U.S. Provisional Patent Application No. 63/321,047, filed Mar. 17, 2022, which is hereby incorporated by reference herein in its entirety.

### FIELD

This disclosure relates generally to electronic devices and, more particularly, to electronic devices with wireless circuitry.

### BACKGROUND

Electronic devices are often provided with wireless capabilities. An electronic device with wireless capabilities has wireless circuitry that includes one or more antennas. The wireless circuitry is used to perform communications using radio-frequency signals transmitted by the antennas.

In some scenarios, the wireless circuitry is also used to perform sensing operations to detect the distance between an external object and the electronic device. It can be particularly difficult to detect this distance with high accuracy, particularly when radio-frequency impairments such as on-chip leakage are present in the wireless circuitry.

### SUMMARY

An electronic device may include wireless circuitry controlled by one or more processors. The wireless circuitry may include communications circuitry for performing wireless communications. The wireless circuitry may include sensing circuitry for performing range detection on an external object. The sensing circuitry may include a transmit path coupled to a transmit antenna. The sensing circuitry may include a receive path coupled to a receive antenna. The transmit path may include a signal generator.

During range detection operations, the signal generator may generate signal bursts. A phase shifter may be disposed on the transmit path. A real-time phase control circuit may toggle the phase shifter between a first state and a second state during transmission of the signal bursts. In the first state, the phase shifter receives a first phase vector element. The first phase vector element may control the phase shifter to apply a first phase shift to the signal bursts. In the second state, the phase shifter receives a second phase vector element. The second phase vector element may control the phase shifter to apply a second phase shift to the signal bursts. The second phase vector element may be an inverse of the first phase vector element. The second phase shift may be 180 degrees out-of-phase with respect to the first phase shift. The transmit antenna may be integrated into a transmit phased antenna array if desired. Phase shifters in the transmit phased antenna array may be toggled between the first and second states without changing a beam pointing direction of the signal beam produced by the transmit phased antenna array.

The receive path may be used to receive first reflected signals while the signal bursts are transmitted using the phase shifter in the first state. The receive path may also be used to receive second reflected signals while the signal bursts are transmitted using the phase shifter in the second state. Mixer circuitry may downconvert the first reflected signals to first baseband signals. The mixer circuitry may downconvert the second reflected signals to second baseband signals. The second baseband signals may be subtracted from the first baseband signals to recover a signal of interest associated with reflection of the transmitted signal bursts off an external object. Toggling the phase shifter between the first and second states and performing this subtraction operation may serve to remove the effects of on-chip leakage and/or other radio-frequency impairments on the signal-of-interest (e.g., without increasing physical separation between the transmit and receive paths). The signal-of-interest may then be used to accurately detect a range between the device and the external object.

An aspect of the disclosure provides an electronic device. The electronic device can include a first antenna coupled to a transmit path and configured to transmit a radio-frequency signal. The electronic device can include a second antenna coupled to a receive path. The electronic device can include a phase shifter disposed on the transmit path or the receive path, the phase shifter having a first state in which the phase shifter applies a first phase shift during transmission of the radio-frequency signal by the first antenna and having a second state in which the phase shifter applies a second phase shift during transmission of the radio-frequency signal by the first antenna, the second phase shift being 90-270 degrees out-of-phase with respect to the first phase shift. The electronic device can include one or more processors. The one or more processors can be configured to use the second antenna to receive a first reflected signal while the phase shifter is in the first state. The one or more processors can be configured to use the second antenna to receive a second reflected signal while the phase shifter is in the second state. The one or more processors can be configured to detect a range between the electronic device and an external object based on the first reflected signal and the second reflected signal.

An aspect of the disclosure provides a method of operating an electronic device. The method can include with a signal generator, generating a first signal burst. The method can include with a phase shifter, applying a first phase shift to the first signal burst. The method can include with a first antenna, transmitting the first signal burst. The method can include with a second antenna, receiving first reflected signals corresponding to the first signal burst. The method can include with the signal generator, generating a second signal burst. The method can include with the phase shifter, applying a second phase shift to the second signal burst, the second phase shift being 170-190 degrees out-of-phase with respect to the first phase shift. The method can include with the second antenna, receiving second reflected signals corresponding to the second signal burst. The method can include with one or more processors, detecting a range to an external object based on the first reflected signals and the second reflected signals.

An aspect of the disclosure provides a method of operating wireless circuitry having a phase shifter communicably coupled to a transmit antenna and having a receive antenna. The method can include with one or more processors, providing a first phase vector element to the phase shifter. The method can include with the transmit antenna, transmitting a first radio-frequency signal while the first phase vector element is provided to the phase shifter. The method can include with the receive antenna, receiving a second radio-frequency signal while the transmit antenna transmits the first radio-frequency signal. The method can include with the one or more processors, providing a second phase vector element to the phase shifter, the second phase vector element being an inverse of the first phase vector element. The method can include with the transmit antenna, transmitting a third radio-frequency signal while the second phase vector element is provided to the phase shifter. The method can include with the receive antenna, receiving a fourth radio-frequency signal while the transmit antenna transmits the third radio-frequency signal. The method can include with the one or more processors, detecting a range between the wireless circuitry and an external object based on the third radio-frequency signals and the fourth radio-frequency signals received by the receive antenna.

### BRIEF DESCRIPTION OF THE DRAWINGS

FIG. 1 is a block diagram of an illustrative electronic device having sensing circuitry for performing range detection operations using antennas in accordance with some embodiments.

FIG. 2 is a circuit block diagram of illustrative sensing circuitry that mitigates on-chip leakage and/or other radio-frequency impairments while performing range detection operations in accordance with some embodiments.

FIG. 3 is a flow chart of illustrative operations involved in using sensing circuitry to mitigate on-chip leakage and/or other radio-frequency impairments in accordance with some embodiments.

FIG. 4 is a plot of signal level as a function of frequency that shows how illustrative sensing circuitry may remove on-chip leakage to retrieve a signal-of-interest for performing range detection in accordance with some embodiments.

FIG. 5 is a diagram of an illustrative phased antenna array that may generate a signal beam in a selected beam pointing direction while also mitigating on-chip leakage and/or other radio-frequency impairments for performing range detection in accordance with some embodiments.

FIG. 6 is a flow chart of illustrative operations involved in using a phased antenna array to mitigate on-chip leakage and/or other radio-frequency impairments for performing range detection while steering a corresponding signal beam in different beam pointing directions in accordance with some embodiments.

FIG. 7 is a table of illustrative phase configurations that may be provided to two antennas in a phased antenna array to mitigate on-chip leakage and/or other radio-frequency impairments for performing range detection while steering a corresponding signal beam in different beam pointing directions in accordance with some embodiments.

### DETAILED DESCRIPTION

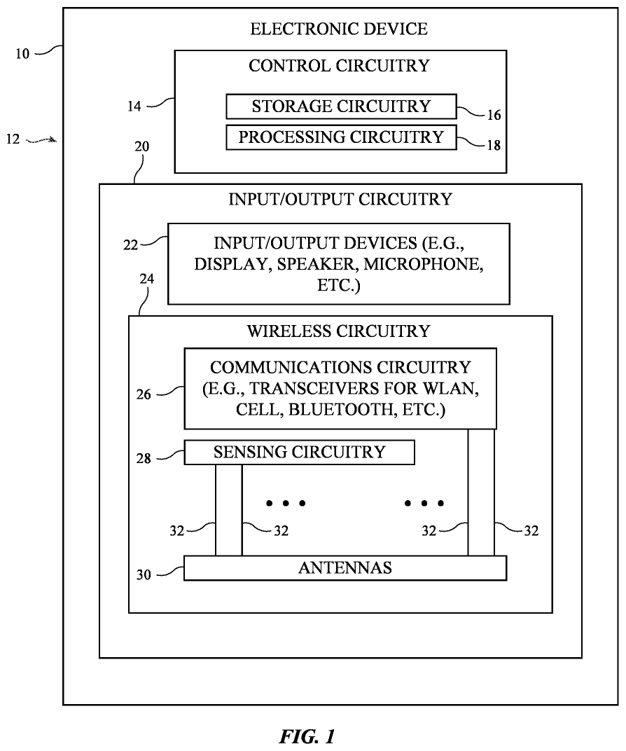

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors, microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, 6G protocols, etc.), antenna diversity protocols, satellite navigation system protocols (e.g., global positioning system (GPS) protocols, global navigation satellite system (GLONASS) protocols, etc.), antenna-based spatial ranging protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications and radio-based sensing operations. Wireless circuitry 24 (sometimes referred to herein as wireless communications circuitry 24) may include two or more antennas 30. Wireless circuitry 24 may also include baseband processor circuitry, transceiver circuitry, amplifier circuitry, filter circuitry, switching circuitry, analog-to-digital converter (ADC) circuitry, digital-to-analog converter (DAC) circuitry, radio-frequency transmission lines, and/or any other circuitry for transmitting and/or receiving radio-frequency signals using antennas 30.

Antennas 30 may be formed using any desired antenna structures for conveying radio-frequency signals. For example, antennas 30 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antennas 30 over time. If desired, two or more of antennas 30 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given beam pointing direction. The term “convey radio-frequency signals” as used herein means the transmission and/or reception of the radio-frequency signals (e.g., for performing unidirectional and/or bidirectional wireless communications with external wireless communications equipment). Antennas 30 may transmit the radio-frequency signals by radiating the radio-frequency signals into free space (or to free space through intervening device structures such as a dielectric cover layer). Antennas 30 may additionally or alternatively receive the radio-frequency signals from free space (e.g., through intervening devices structures such as a dielectric cover layer). The transmission and reception of radio-frequency signals by antennas 30 each involve the excitation or resonance of antenna currents on an antenna resonating element in the antenna by the radio-frequency signals within the frequency band(s) of operation of the antenna.

Wireless circuitry 24 may include communications circuitry 26 (sometimes referred to herein as wireless communications circuitry 26) for transmitting and/or receiving wireless communications data using antennas 30. Communications circuitry 26 may include baseband circuitry (e.g., one or more baseband processors) and one or more radios (e.g., radio-frequency transceivers, modems, etc.) for conveying radio-frequency signals using one or more antennas 30. Communications circuitry 26 may use antennas 30 to transmit and/or receive radio-frequency signals that convey the wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data packets such as wireless data associated with a telephone call, streaming media content, Internet browsing, wireless data associated with software applications running on device 10, email messages, etc.

Communications circuitry 26 may transmit and/or receive radio-frequency signals within corresponding frequency bands at radio frequencies (sometimes referred to herein as communications bands or simply as “bands”). The frequency bands handled by communications circuitry 26 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

In addition to conveying wireless communications data, wireless circuitry 24 may also use antennas 30 to perform radio-frequency sensing operations (sometimes referred to herein as radio-based sensing operations or simply as sensing operations). The sensing operations may allow device 10 to detect (e.g., sense or identify) the presence, location, orientation, and/or velocity (motion) of objects external to device 10. Detecting, sensing, or identifying the presence, location, orientation, and/or velocity (motion) of an external object at any given time or over a given time period may sometimes be referred to herein simply as detecting the external object or performing spatial ranging operations, ranging operations, or range detection. The sensing operations may be performed over a relatively short range such as ranges of a few cm from antennas 30 (e.g., using voltage standing wave ratio detector(s) coupled to antennas 30) or over longer ranges such as ranges of dozens of cm, a few meters, dozens of meters, etc. In one implementation that is described herein as an example, the sensing operations may detect the location of the external object as the distance (sometimes referred to herein as range R) between device 10 (e.g., antennas 30) and the external object.

Control circuitry 14 may use the detected presence, location, orientation, and/or velocity of the external objects to perform any desired device operations. As examples, control circuitry 14 may use the detected presence, location (e.g., range R), orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer a radio-frequency signal beam produced by antennas 30 for communications circuitry 26 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may include sensing circuitry 28 for performing sensing operations using antennas 30. Sensing circuitry 28 may include a sensing transmitter (e.g., transmitter circuitry including signal generators, synthesizers, etc.), a sensing receiver, mixer circuitry, amplifier circuitry, filter circuitry, baseband circuitry, ADC circuitry, DAC circuitry, and/or any other desired components used in performing sensing operations using antennas 30. Sensing circuitry 28 may perform the sensing operations using radio-frequency sensing signals that are transmitted by antennas 30 and using reflected versions of the radio-frequency sensing signals that have reflected off external objects around device 10 (e.g., using a frequency-modulated continuous-wave (FMCW) scheme, a full-duplex ranging scheme, etc.). Antennas 30 may include separate antennas for conveying wireless communications data for communications circuitry 26 and for conveying sensing signals or may include one or more antennas 30 that are used to both convey wireless communications data and to perform sensing operations. Using a single antenna 30 to both convey wireless communications data and perform sensing operations may, for example, serve to minimize the amount of space occupied in device 10 by antennas 30.

Sensing circuitry 28 may be coupled to antennas 30 over at least two radio-frequency transmission line paths 32. Communications circuitry 26 may be coupled to antennas 30 over at least one radio-frequency transmission line path 32. Separate radio-frequency transmission line paths 32 may couple sensing circuitry 28 and communications circuitry 26 to antennas 30 (e.g., as shown in FIG. 1) or one or more radio-frequency transmission line paths 32 may couple one or more antennas 30 to both sensing circuitry 28 and communications circuitry 26. Radio-frequency transmission line paths 32 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission line paths 32 may be integrated into rigid and/or flexible printed circuit boards if desired. Radio-frequency front end (RFFE) modules may be interposed on one or more radio-frequency transmission line paths 32. The radio-frequency front end modules may include substrates, integrated circuits, chips, or packages that are separate from sensing circuitry 28 and communications circuitry 26 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission line paths 32.

The example of FIG. 1 is merely illustrative. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of communications circuitry 26 and/or sensing circuitry 28. The baseband circuitry may, for example, access a communication protocol stack on control circuitry 14 (e.g., storage circuitry 20) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer. If desired, the PHY layer operations may additionally or alternatively be performed by radio-frequency (RF) interface circuitry in wireless circuitry 24.

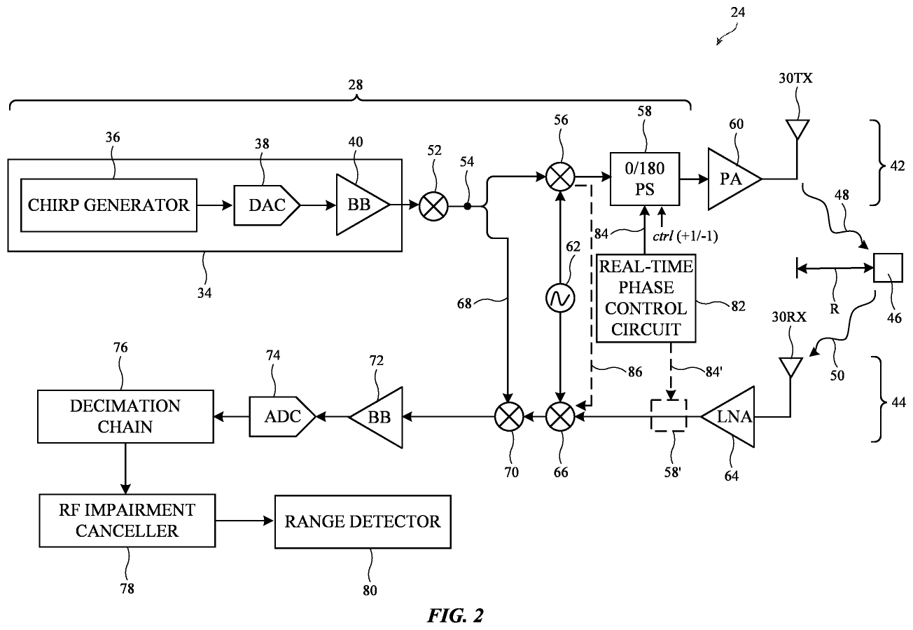

FIG. 2 is a circuit diagram showing how sensing circuitry 28 may use antenna(s) 30 for performing spatial ranging operations. As shown in FIG. 2, sensing circuitry 28 may include one or more transmit (TX) paths 42 (sometimes referred to herein as TX chains 42 or TX circuitry 42) coupled to a first antenna 30 such as transmit antenna 30TX. Sensing circuitry 28 may also include one or more receive (RX) paths 44 (sometimes referred to herein as RX chains 44 or RX circuitry 44) coupled to a second antenna 30 such as receive antenna 30RX.

As shown in FIG. 2, transmit path 42 may include a signal generator 34, a transmit in-phase quadrature-phase (I/Q) modulator 52, a signal splitter 54, a mixer such as radio-frequency TX mixer 56, a phase shifter such as phase shifter 58, and amplifier circuitry such as power amplifier (PA) 60. The output of signal generator 34 may be coupled to the input of I/Q modulator 52. Signal splitter 54 may have an input coupled to the output of I/Q modulator 52 and may have a first output coupled to a first input of radio-frequency TX mixer 56. Radio-frequency TX mixer 56 may have an output coupled to the input of phase shifter (PS) 58. Phase shifter 58 may have an output coupled to the input of power amplifier 60. Power amplifier 60 may have an output coupled to transmit antenna 30TX (e.g., over a corresponding transmission line path 32 of FIG. 1).

Receive path 44 may include amplifier circuitry such as low noise amplifier (LNA) 64, a first mixer such as radio-frequency RX mixer 66, a second mixer such as de-chirp mixer 70, a baseband (BB) amplifier such as amplifier 72, an analog-to-digital converter (ADC) 74, and a decimation chain 76. The input of LNA 64 may be coupled to receive antenna 30RX (e.g., over a corresponding transmission line path 32 of FIG. 1). The output of LNA 64 may be coupled to a first input of radio-frequency RX mixer 66. The output of radio-frequency RX mixer 66 may be coupled to a first input of de-chirp mixer 70. The output of de-chirp mixer 70 may be coupled to the input of amplifier 72. The output of amplifier 72 may be coupled to the input of ADC 74. The output of ADC 74 may be coupled to the input of decimation chain 76. The output of decimation chain 76 may be coupled to the input of range detection circuitry in sensing circuitry 28. The range detection circuitry may include a radio-frequency (RF) impairment canceller 78 and a range detector 80. The input of radio-frequency impairment canceller 78 may be coupled to the output of decimation chain 76. The output of RF impairment canceller 78 may be coupled to the input of range detector 80.

In the example of FIG. 2, sensing circuitry 28 has an FMCW radar architecture in which signal generator 34 generates chirp signals that are provided to I/Q modulator 52. Signal splitter 54 may have a second output coupled to a second input of de-chirp mixer 70 over de-chirp path 68. Mixers 56 and 66 may have second inputs that receive a local oscillator (LO) signal from LO generator 62. Signal generator 34 may include a chirp generator 36 having an output coupled to digital-to-analog converter (DAC) 38 (e.g., a first DAC for converting in-phase samples and a second DAC for converting quadrature-phase samples). The output of DAC 38 may be coupled to the input of a baseband amplifier such as amplifier 40. The output of amplifier 40 may be coupled to the input of I/Q modulator 52.

The example of FIG. 2 is merely illustrative. If desired, DAC 38 may be replaced with a swept synthesizer. In some configurations, DAC 38 and I/Q modulator 52 may be replaced with a swept synthesizer. Sensing circuitry 28 need not be implemented using an FMCW radar architecture and may, in general, be implemented using any desired radar architecture. Additional components (e.g., filters, amplifiers, switches, impedance matching networks, couplers, tuning circuits, transmission lines, mixers, converters, transformers, etc.) may be interposed at one or more locations on transmit path 42 and/or receive path 44 if desired. While described herein in connection with performing spatial ranging operations (e.g., using chirp signals), transmit antenna 30TX may also be used to transmit and/or receive radio-frequency signals that convey wireless communications data for communications circuitry 26 (FIG. 1) if desired. Similarly, receive antenna 30RX may also be used to transmit and/or receive radio-frequency signals that convey wireless communications data for communications circuitry 26 if desired. The transmit antenna and the receive antenna may be the same antenna or portions of the same antenna if desired (e.g., a given transmit path and receive path may share the same antenna such as for operating in a voltage standing wave ration (VSWR) mode or an ultra-short range radar mode).

When performing spatial ranging operations, signal generator 34 may generate ranging signals for transmission over transmit path 42. For example, chirp generator 36 may generate a digital chirp signal, which is converted to an analog chirp signal by DAC 38 and amplified by amplifier 40 prior to passing to I/Q modulator 52. The chirp signal generated by signal generator 34 has a frequency that periodically ramps up over time (e.g., where the chirp signals are sawtooth signals, ramped signals, step signals, or linearly increasing or decreasing in frequency as a function of time). This example is merely illustrative and, in general, signal generator 34 may transmit ranging signals having any desired waveforms for performing spatial ranging operations.

I/Q modulator 52 may perform I/Q modulation on the chirp signal produced by signal generator 34. Signal splitter 54 may pass the chirp signal to radio-frequency TX mixer 56 and to de-chirp mixer 70 over de-chirp path 68. If desired, one or more amplifiers (not shown) may be interposed on de-chirp path 68 to boost the amplitude of the chirp signals provided to de-chirp mixer 46. Radio-frequency TX mixer 56 may upconvert the chirp signal to radio-frequencies using the LO signal received from LO generator 62. Power amplifier 60 may amplify the radio-frequency chirp signal. Transmit antenna 30TX may transmit the amplified chirp signal as radio-frequency signals 48. Radio-frequency signals 48 may reflect off objects external to device 10, such as external object 46 located at range (distance) R from device 10, as reflected signals 50 (e.g., a reflected version of radio-frequency signals 48 after reflection off external object 46). External object 46 may be, for example, the ground, a building, part of a building, a wall, furniture, a ceiling, a person, a body part (e.g., the head, hand, or other body part of the user of device 10 or other humans in the vicinity of device 10), an animal, a vehicle, a landscape or geographic feature, an obstacle, external communications equipment, another device of the same type as device 10 or a peripheral/accessory device such as a gaming controller, stylus (e.g., for providing input to a touch and/or force-sensitive display on device 10), or remote control, or any other physical object or entity that is external to device 10.

Receive antenna 30RX may receive reflected signals 50 and may pass the reflected signals down receive path 44. LNA 64 may amplify the reflected signals. Radio-frequency RX mixer 66 may use the LO signal from LO generator 62 to downconvert the reflected signals from radio-frequencies to baseband (or an intermediate frequency). The reflected signals may include the chirp signals transmitted by transmit antenna 30TX but that have reflected off external object 46 and that have been received by receive antenna 30RX. De-chirp mixer 70 may receive reflected sensing 50 at its first input (e.g., from radio-frequency RX mixer 66). De-chirp mixer 70 may also receive the corresponding transmitted chirp signal over de-chirp path 68. De-chirp mixer 70 may mix the signals received at its first and second inputs to produce or generate baseband signals that correspond to beats associated with the difference in phase between the chirp signal in the transmitted radio-frequency signals 48 and the chirp signal in the received reflected signals 50. The baseband may therefore sometimes be referred to as beat signals. This example is merely illustrative. If desired, the de-chirp mixer may be replaced with a downconverting mixer and an ADC that receives an FMCW/chirp wideband signal (e.g., in implementations where joint communications and sensing is performed). The de-chirp operation that is otherwise performed by the de-chirp mixer (sometimes also called cross-correlation or pulse compression) may then be performed in the digital domain (e.g., by a cross-correlation block in the digital domain).

Amplifier 72 may amplify the baseband signals, which are converted from the analog domain to the digital domain by ADC 74. Decimation chain 76 may decimate the digital signals, which are then passed to the range detection circuitry of sensing circuitry 28. The range detection circuitry may process the digital signals to identify range R between external object 46 and device 10, and/or to identify/detect the presence, location, orientation, and/or velocity of external object 46. Using sensing circuitry 28 to measure range R may offer several advantages over camera-based sensors for external object 46. For example, sensing circuitry 28 may provide improved privacy relative to camera-based sensors, a smaller radio-frequency antenna form factor, a wider angle of view than camera-based sensors, and the ability to function across lighting conditions. Sensing circuitry 28 may detect range R at ranges up to 20 cm or more, as an example.

During signal transmission, radio-frequency (RF) impairments may be present in sensing circuitry 28 that serve to limit the accuracy and/or precision with which sensing circuitry 28 is able to detect range R. The RF impairments may include on-chip leakage, RX DC offset, intermodulation products and harmonics related to parasitic/on-chip leakage, antenna crosstalk, the IM3 product between antenna crosstalk and parasitic/on-chip leakage created by a (2*F_crosstalk−F_leakage) mechanism, and/or other impairments. On-chip leakage, for example, occurs when some of the radio-frequency signals on transmit path 42 leak from transmit path 42 onto receive path 44, as shown by arrow 86 (e.g., where the leakage is then received at radio-frequency RX mixer 66). The signal received at the first input of radio-frequency RX mixer 66 will therefore include a signal-of-interest (SOI) corresponding to the transmitted chirp signals received by receive antenna 30RX in reflected signals 50, as well as an additional non-SOI corresponding to the on-chip leakage. As external object 46 will often have a relatively small radar cross section (e.g., the size of a human finger or smaller) and can be located very close to antennas 30TX/30RX, there may be very little time/range separation between the SOI and the non-SOI produced by the on-chip leakage. At the same time, the non-SOI produced by the on-chip leakage can be several orders of magnitude higher than the received SOI. This can limit the ability of the range detection circuitry in sensing circuitry 28 to accurately detect the SOI in the received signal, which is then used to identify range R, leading to inaccurate or imprecise measurements in range R.

In some scenarios, on-chip leakage can be minimized by forming transmit path 42 and receive path 44 on separate chips and/or by increasing the physical separation of transmit path 42 from receive path 44. However, such physical separation can undesirably increase the chip floorplan of wireless circuitry 24, consuming excessive power and limiting the amount of space in device 10 available for forming other components. In addition, increasing physical separation may only offer marginal improvements to the ratio between the SOI and the non-SOI.

To mitigate these issues while allowing sensing circuitry 28 to accurately and precisely measure range R without increasing the physical separation between transmit path 42 and receive path 44, phase shifter 58 may by interposed on transmit path 42 between radio-frequency TX mixer 56 and power amplifier 60 (or elsewhere on transmit path 42). Phase shifter 58 may have a first state in which phase shifter 58 imparts a first phase shift (+1) on the signals transmitted over transmit path 42 and a second state in which phase shift 58 imparts a second phase shift (−1) that is 180 degrees out of phase with respect to the first phase shift on the signals transmitted over transmit path 42 (e.g., phase shifter 58 may be a 0/180-degree phase shifter, sometimes also referred to as a +1/−1 phase shifter or a two-state phase shifter).

Sensing circuitry 28 may also include a real-time phase control circuit 82 that is coupled to phase shifter 58 over control path 84. Real-time phase control circuit 82 may provide a control signal ctrl to phase shifter 58 that switches/toggles phase shifter 58 between the first and second states in real time during transmission of radio-frequency signals 48. For example, during a first time period, signal generator 34 may generate a first burst of chirp signals (or other transmit signals used for ranging). Signal splitter 54 may split the first burst of chirp signals between radio-frequency TX mixer 56 and de-chirp mixer 68 (over de-chirp path 68). Real-time phase control circuit 82 may place phase shifter 58 in the first state to control phase shifter 58 to apply the first phase to the first burst of chirp signals. Transmit antenna 30TX may then transmit the first burst of chirp signals at the first phase as radio-frequency signals 48.

Receive antenna 30RX may receive the first burst of chirp signals in reflected signals 50. De-chirp mixer 70 may mix the first burst of chirp signals in reflected signals 50 with the first burst of chirp signals as received from signal splitter 54 over de-chirp path 68 to recover first baseband signals. The first baseband signals may be measured by RF impairment canceler 78 and stored to a buffer for subsequent processing. The first baseband signals may include both the SOI from reflected signals 50 as received from external object 46 and a non-SOI due to RF impairments such as the on-chip leakage shown by arrow 86.

During a second time period beginning immediately after the first time period, signal generator 45 may generate a second burst of chirp signals (or other transmit signals used for ranging). Signal splitter 54 may split the second burst of chirp signals between radio-frequency TX mixer 56 and de-chirp mixer 68 (over de-chirp path 68). Real-time phase control circuit 82 may switch phase shifter 58 to the second state to control phase shifter 58 to apply the second phase to the second burst of chirp signals. Transmit antenna 30TX may then transmit the second burst of chirp signals at the second phase as radio-frequency signals 48 (e.g., 180 degrees out of phase with respect to the first burst of chirp signals transmitted by transmit antenna 30TX).

Receive antenna 30RX may receive the second burst of chirp signals in reflected signals 50. De-chirp mixer 70 may mix the second burst of chirp signals in reflected signals 50 with the second burst of chirp signals as received from signal splitter 54 over de-chirp path 68 to recover second baseband signals. The second baseband signals may be measured by RF impairment canceler 78 and stored to the buffer for subsequent processing. The second baseband signals may include both the SOI from reflected signals 50 as received from external object 46 and a non-SOI due to RF impairments such as the on-chip leakage shown by arrow 86.

RF impairment canceller 78 may then subtract the second baseband signals stored on the buffer from the first baseband signals stored on the buffer (e.g., RF impairment canceller 78 may generate a difference value between the first and second reflected signals using a subtractor). The 180-degree phase difference between the first and second baseband signals may cause this subtraction to recover the SOI from the baseband signals while removing the non-SOI produced by the RF impairments (e.g., on-chip leakage, RX DC offset, etc.). Range detector 80 may then process the recovered SOI to identify (e.g., generate, estimate, produce, compute, calculate, recover, measure, etc.) range R between device 10 and external object 46. Removing the RF impairment using phase shifter 58 and RF impairment canceller 78 may cause the SNDR of the SOI to be as many as 30 dB higher than in scenarios where the RF impairments have not been canceled out by phase shifter 58 and RF impairment canceller 78. As such, range detector 80 may more accurately and precisely measure range R despite the presence of RF impairments such as on-chip leakage or RX DC offset in sensing circuitry 28, without requiring changes to the physical layout of wireless circuitry 24. In addition, sensing circuitry 28 has no sensitivity to error in phase shifter 58 and may perform range detection without any impact to air time or SNR loss.

Range detector 80 and RF impairment canceller 78 may be implemented in digital logic on sensing circuitry 28, for example. The operations of RF impairment canceller 78, range detector 80, and real-time phase control circuit 82 may be performed and/or controlled by one or more processors. RF impairment canceller 78, range detector 80, and/or real-time phase control circuit 82 may be implemented in hardware (e.g., using one or more logic gates, adders, subtractors, multipliers, dividers, other circuit components, diodes, transistors, switches, arithmetic logic units (ALUs), registers, buffers, application-specific integrated circuits, field-programable gate arrays, one or more processors, look-up tables, etc.) and/or may be implemented in software (e.g., running on storage circuitry and executed by one or more processors). Some or all of these components may form part of control circuitry 14 of FIG. 1 and the operations of some or all of these components may be performed by one or more processors on UE device 10, for example.

The example of FIG. 2 in which phase shifter 58 is interposed on transmit path 42 is merely illustrative. If desired, phase shifter 58 may be interposed on receive path 44 between LNA 64 and the on-chip leakage path (arrow 86), as shown by dashed box 58′. In these implementations, the phase shifter may be controlled by control signal ctrl received over control path 84. The operation of the phase shifter when located on receive path 44 may be similar to that of the phase shifter when located on transmit path 42. Disposing phase shifter 58 on receive path 44 may be particularly beneficial in joint communication and sensing arrangements (e.g., where the waveform transmitted by transmit antenna 30TX is used to both convey wireless communications data and perform range detection). For example, although changing the phase vector in the transmit path does not modify the signal beam direction (e.g., as formed by a phased antenna array including transmit antenna 30TX), it does change the phase of the communication signal, which could destroy the decoded signal (assuming the communication modulation includes some form of phase modulation) if the external communications equipment is unaware of the intent to change the transmit signal phase. In contrast, placing phase shifter 58 on receive path 44 is invisible to the external communications equipment.

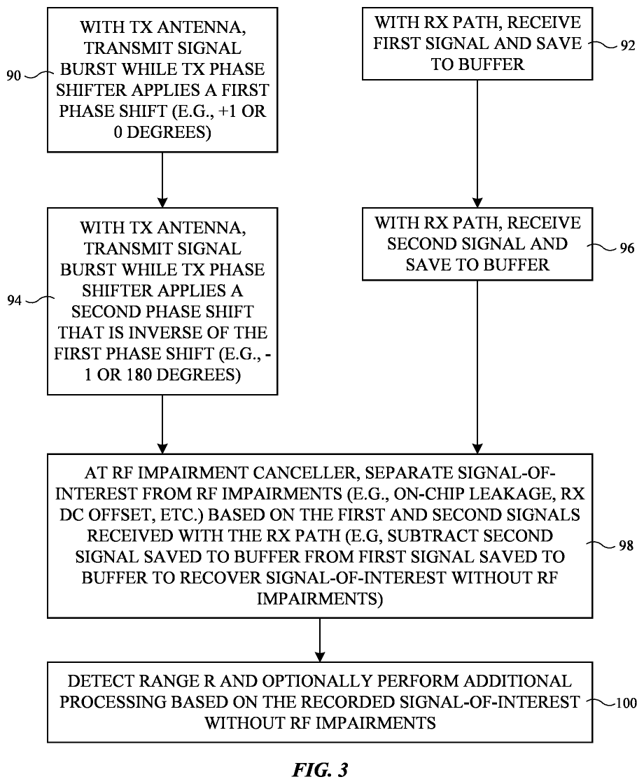

FIG. 3 is a flow chart of illustrative operations involved in using sensing circuitry 28 to measure range R (e.g., while mitigating the effects of RF impairments such as on-chip leakage and RX DC offset).

At operation 90, signal generator 34 may generate a first signal burst (e.g., a burst of chirp signals or other ranging signals) while real-time phase control circuit 82 controls phase shifter 58 to apply a first phase shift to the first signal burst (e.g., a 0-degree phase shift). The first phase shift may also be denoted as +1 (e.g., where control signal ctrl controls phase shifter 58 using a corresponding element of a phase vector multiplied by unity +1). Transmit antenna 30TX may transmit the first signal burst while de-chirp path 68 also routes the first signal burst to de-chirp mixer 70 over de-chirp path 68 and while on-chip leakage flows from transmit path 42 to receive path 44 (as shown by arrow 86 of FIG. 2).

Operation 92 may be performed concurrently with operation 90. At operation 92, receive path 44 may receive a first signal and may store the first signal to a buffer (e.g., at RF impairment canceller 78). The first signal may include reflected signals 50 that include a SOI (e.g., the first signal burst transmitted by transmit antenna 30TX). The first signal may also include a non-SOI such as an on-chip leakage signal.

At operation 94, signal generator 34 may generate a second signal burst while real-time phase control circuit 82 controls phase shifter 58 to apply, to the second signal burst, a second phase shift that is the inverse of (e.g., 180-degrees out-of-phase with) the first phase shift (e.g., a 180-degree phase shift). The second phase shift may also be denoted as −1 (e.g., where control signal ctrl controls phase shifter 58 using a corresponding element of a phase vector multiplied by −1, which serves to invert the element of the phase vector). Transmit antenna 30TX may transmit the second signal burst while de-chirp path 68 also routes the second signal burst to de-chirp mixer 70 over de-chirp path 68 and while on-chip leakage flows from transmit path 42 to receive path 44.

Operation 96 may be performed concurrently with operation 94. At operation 96, receive path 44 may receive a second signal and may store the second signal to the buffer. The second signal may include reflected signals 50 that include a SOI (e.g., the first signal burst transmitted by transmit antenna 30TX). The second signal may also include a non-SOI such as an on-chip leakage signal.

At operation 98, RF impairment canceller 78 may separate the SOI from the RF impairments in (based on) the signals received over receive path 44. For example, RF impairment canceller 78 may subtract the second signal received over receive path 44 from the first signal (which is 180-degrees out-of-phase with the second signal) received over receive path 44 to retrieve/recover the SOI without the RF impairments (e.g., without the non-SOI from on-chip leakage, RX DC offset, etc.).

At operation 100, range detector 80 may detect range R based on the recovered SOI without RF impairments as produced by RF impairment canceller 78. Control circuitry 14 (FIG. 1) may optionally perform any desired additional processing operations based on range R and/or based on the recovered SOI without RF impairments. For example, control circuitry 14 may detect the spatial location and/or velocity of external object 46, may detect a user input gesture, may detect the presence of a user's body part, may adjust (e.g., reduce) maximum transmit power level and/or transmit power level of one or more antennas 30, may switch different antenna(s) 30 into use, may identify an angle-of-arrival of reflected signals 50, etc. Processing may then loop back to operations 90 and 92 to continue to detect and track range R without RF impairments over time.

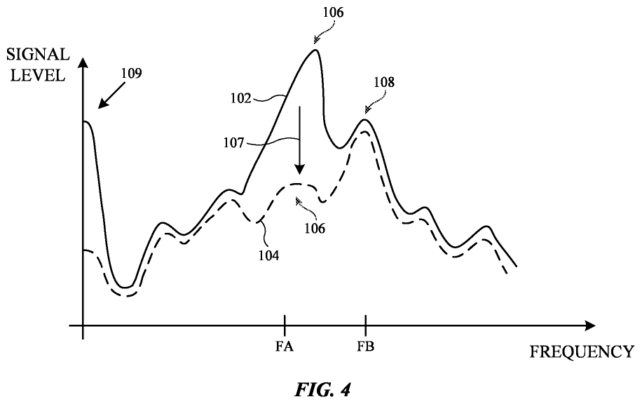

FIG. 4 is a plot of signal level as a function of frequency of the received signals processed by range detector 80 for detecting range R (e.g., after converting time-domain signals to the frequency domain using a fast Fourier transform). Curve 102 plots the signal as received without using phase shifter 58 and RF impairment canceller 78 to remove RF impairments such as on-chip leakage from the signal. As shown by curve 102, this signal includes a first peak 106 (e.g., at frequency FA) produced by on-chip leakage and includes a second peak 108 (e.g., at frequency FB) produced by the SOI in reflected signals 50. The signal may also have a DC peak 109. The on-chip leakage associated with first peak 106 may even be much stronger than the SOI associated with second peak 108.

Curve 104 plots the signal as received while using phase shifter 58 and RF impairment canceller 78 to remove RF impairments such as on-chip leakage from the signal (e.g., from processing the operations of FIG. 3). As shown by curve 104, phase shifter 58 and RF impairment canceller 78 may cause a significant reduction or removal of the peak 106 caused by on-chip leakage (as shown by arrow 107) as well as the DC peak 109, leaving the SOI associated with peak 108 in the signal. Range detector 80 may then more easily resolve the SOI in the signal (e.g., by peak-detecting peak 108) for accurately detecting range R due to the removal of on-chip leakage from the signal.

If desired, transmit antenna 30TX may also form part of a phased antenna array used to convey wireless communications data (e.g., wireless data organized into packets, frames, etc. under a wireless communications protocol such as a 3GPP 5G NR protocol) over a corresponding signal beam oriented in a selected beam pointing direction (e.g., in an integrated radar and communication configuration). In these arrangements, phase shifters are used to adjust phase between each of the antennas in the phased antenna array to orient the signal beam in the selected beam pointing direction. These phase shifters may also be used as phase shifter 58 of FIG. 2 for the purpose of mitigating on-chip leakage or other RF impairments while performing range detection.

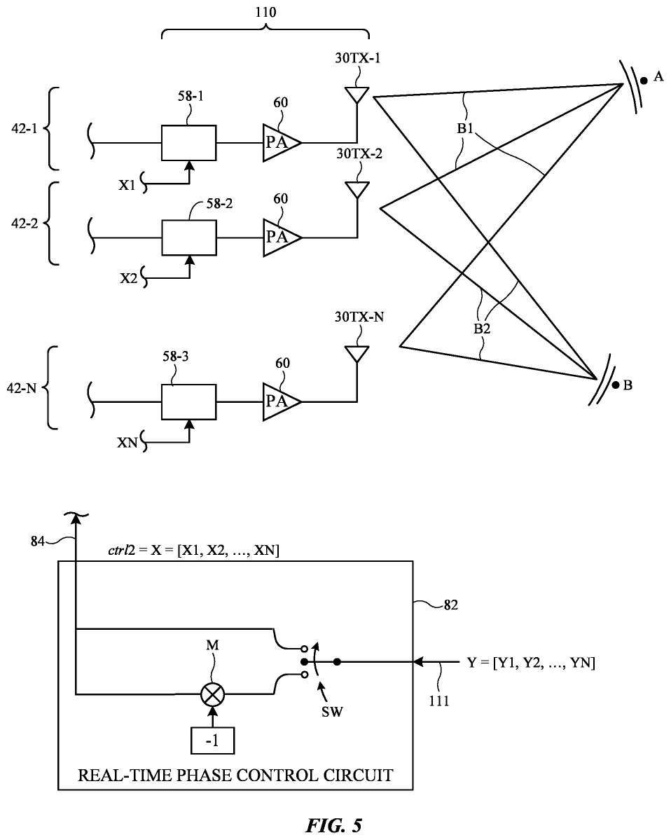

FIG. 5 is a circuit diagram showing how one such phased antenna array 110 may be operated to both steer a corresponding signal beam in a selected beam pointing direction and to perform range detection while mitigating on-chip leakage or other RF impairments. As shown in FIG. 5, phased antenna array 110 may include a set of N transmit antennas 30TX (e.g., a first transmit antenna 30TX-1, a second antenna 30TX-2, an Nth antenna 30TX-N, etc.). Each transmit antenna 30TX may be coupled to a respective transmit path 42 (e.g., transmit path 42-1 may be coupled to transmit antenna 30TX-1, transmit path 42-2 may be coupled to transmit antenna 30TX-2, etc.).

Each transmit path 42 of phased antenna array 110 may include the components shown in FIG. 2 or other components for transmitting ranging signals in addition to transmitting wireless communications data using radio-frequency signals 48. For example, each transmit path 42 may include a respective power amplifier 60 and a respective phase shifter 58 (e.g., transmit path 42-1 may include a first phase shifter 58-1, transmit path 42-2 may include a second phase shifter 58-2, etc.). Each phase shifter 58 may receive a control signal that controls that phase shifter to apply a respective phase to the transmitted signals on its transmit path 42. The control signal applied to each phase shifter 58 may be an element of a corresponding phase vector X (sometimes referred to herein as phase vector elements). For example, phase shifter 58-1 may be controlled by a first element X1 of phase vector X, phase shifter 58-2 may be controlled by a second element X2 of phase vector X, phase shifter 58-N may be controlled by an Nth element XN of phase vector X, etc. In the example of FIG. 5, phase vector X is the control signal ctrl produced by real-time phase control circuit 82 (e.g., real-time phase control circuit 82 controls each of the transmit paths 42 in phased antenna array 110). This is merely illustrative and, if desired, each transmit path 42 may have a respective real-time phase control circuit that provides a respective control signal ctrl that includes the corresponding element of phase vector X.

Real-time phase control circuit 82 may use phase vector X to control the beam pointing direction of phased antenna array 110 while also controlling phase shifters 58 to mitigate RF impairments such as on-chip leakage for performing range detection. As shown in FIG. 5, real-time phase control circuit 82 may receive a phase vector Y that corresponds to a particular beam pointing direction for the signal beam produced by phased antenna array 110. Phase vector Y may be provided by a higher layer or from other control or processing circuitry in device 10 (e.g., from a beam steering codebook stored on device 10). Phase vector Y may include N elements (e.g., Y1, Y2, YN, etc.), where each element is intended to control the phase applied by a respective one of the phase shifters 58 in phased antenna array 110 such that the signals transmitted by each of the corresponding transmit antennas 30TX in phased antenna array 110 constructively and destructively interfere to produce a signal beam B oriented in a selected beam pointing direction (e.g., a direction of peak gain).

For example, when phase vector Y has a first set of elements, the elements may configure phase shifters 58 to apply a first set of phase shifts to the transmitted signals that collectively configure the N transmit antennas 30TX in phased antenna array 110 to produce (form) a signal beam B1 having a beam pointing direction oriented towards point A. When phase vector Y has a second set of elements, the elements may configure phase shifters 58 to apply a second set of phase shifts to the transmitted signals that collectively configure the N transmit antennas 30TX in phased antenna array 110 to produce (form) a signal beam B2 having a beam pointing direction oriented towards point B. This type of beam forming/steering may be used to orient the signal beam in a direction that overlaps external communications equipment such as a wireless base station, a wireless access point, or another device 10. The signal beam may then be used to convey wireless communications data. Such beam steering arrangements are particularly advantageous at high frequencies such as frequencies greater than 10 GHz, due to the high degree of signal attenuation at these frequencies.

Real-time phase control circuit 82 may alter phase vector Y to allow phased antenna array 110 to perform range detection while mitigating on-chip leakage or other RF impairments and without altering the direction of the formed signal beam. For example, real-time phase control circuit 82 may generate the phase vector X used to control phase shifters 58 based on phase vector Y. Real-time phase control circuit 82 may configure phase vector X to have elements identical to the elements in phase vector Y and to have elements that are the inverse of the elements in phase vector Y during alternating time periods (e.g., during iterations of operations 90-96 of FIG. 3).

For example, real-time phase control circuit 82 may generate phase vector X having identical elements to the elements of phase vector Y (e.g., X1=Y1, X2=Y2, XN=YN, etc.) during transmission of a first signal burst using phased antenna array 110 (e.g., during operations 90 and 92 of FIG. 3). Real-time phase control circuit 82 may then generate phase vector X having inverse elements to the elements of phase vector Y (e.g., X1=−Y1, X2=−Y2, XN=−YN, etc.) during transmission of a second signal burst immediately subsequent to the first signal burst (e.g., during operations 94 and 96 of FIG. 3). Inverting the elements of phase vector Y (e.g., setting X1=−Y1, X2=−Y2, XN=−YN, etc.) configures phase shifters 58 to apply an inverse phase shift that is 180-degrees out-of-phase with respect to the phase shift applied by phase shifters 58 when controlled using phase vector elements X1=Y1, X2=Y2, XN=YN, etc. Since all of the phase vector elements are inverted, the relative phasing between the antennas does not change and this change in phase vector X will not change the direction of the signal beam produced by phased antenna array 110. In this way, phased antenna array 110 may be used to perform range detection operations that mitigate on-chip leakage or other RF impairments on top of being steered to perform wireless communications.

Consider one example in which a two-element phased antenna array is controlled using a phase vector Y=[1, j], where the first element (1) of phase vector Y controls phase shifter 58-1 to impart a first phase shift and where the second element (j or the square-root of −1) of phase vector Y controls phase shifter 58-2 to impart a second phase shift 90-degrees out-of-phase with the first phase shift (e.g., because a phase vector element j corresponds to a 90 degree phase shift with respect to a phase vector element of 1). Real-time phase control circuit 82 may generate a phase vector X=[1,j] to control phase shifters 58-1 and 58-2 during the transmission of the first signal burst, which may control the phased antenna array to point the signal beam in a first direction for the first signal burst. For transmission of the second signal burst, real-time phase control circuit 82 may generate a phase vector X=[−1,−j] to control phase shifters 58-1 and 58-2. Phase vector element −1 corresponds to a phase shift that is 180 degrees out-of-phase with respect to the phase shift produced by the corresponding phase vector element 1 in phase vector Y. Phase vector element −j corresponds to a phase shift that is 180 degrees out-of-phase with respect to the phase shift produced by the corresponding phase vector element j in phase vector Y. This will not change the direction of the signal beam but may allow sensing circuitry 28 to mitigate on-chip leakage while processing the received reflected signals (e.g., while processing the operations of FIG. 3).

FIG. 5 shows one example of how real-time phase control circuit 82 may generate phase vector X based on a phase vector Y received over path 111 (e.g., a path communicably coupled to a codebook on device 10). Real-time phase control circuit 82 may, for example, include a multiplier such as multiplier M and switching circuitry such as a switch SW (e.g., as implemented using digital/analog logic in hardware controlled by one or more processors and/or in software executed by one or more processors). Switch SW may have a first terminal coupled to path 111, a second terminal coupled to control path 84, and a third terminal coupled to multiplier M. Multiplier M may be coupled between the third terminal of switch SW and control path 84.

Switch SW may have a first state in which switch SW couples path 111 to control path 84 (e.g., while bypassing multiplier M). In this state, phase vector X (e.g., control signal ctrl) may equal phase vector Y. Real-time phase control circuit 82 may distribute the elements of phase vector X (and thus the elements of phase vector Y) to respective phase shifters 58 in phased antenna array 110. Switch SW may have a second state in which switch SW couples path 111 to multiplier M. In this state, multiplier M may invert each element of phase vector Y (e.g., by performing element-wise multiplication of phase vector Y by −1) to produce phase vector X on control path 84 (e.g., as control signal ctrl). Real-time phase control circuit 82 may distribute the elements of phase vector X (e.g., the inverse of the elements of phase vector Y) to respective phase shifters 58 in phased antenna array 110. These elements of phase vector X will control phase shifters 58 to apply phase shifts that are 180-degrees out-of-phase with respect to the phase shifts that would be produced if phase shifters 58 were controlled only with the non-inverted elements of phase vector Y. This example is merely illustrative and, in general, real-time phase control circuit may include any desired components or logic. Phased antenna array 110 may also be used to receive radio-frequency signals if desired.

In this way, the phase shift settings applied to phased antenna array 110 are not linearly independent, but instead are a rotation of a phase shift vector Y from the point of view of spatial coverage that would result in a beam pointing in the same direction. In phased antenna arrays that are used for performing wireless communications without on-chip leakage mitigated range detection, the objective is to direct radiated signals towards a particular direction and there is no utility in applying phase vectors that differ only by a rotation because a rotation applied to a phase vector setting gives a signal beam that points in the same direction, providing no additional information in absence of an internal leakage path. However, while the arrangement in FIG. 5 would introduce unnecessary cost and complexity to a system that only performs wireless communications, such an arrangement may allow phased antenna array 110 to also perform range detection while mitigating on-chip leakage, similar to as described in connection with FIGS. 2 and 3.

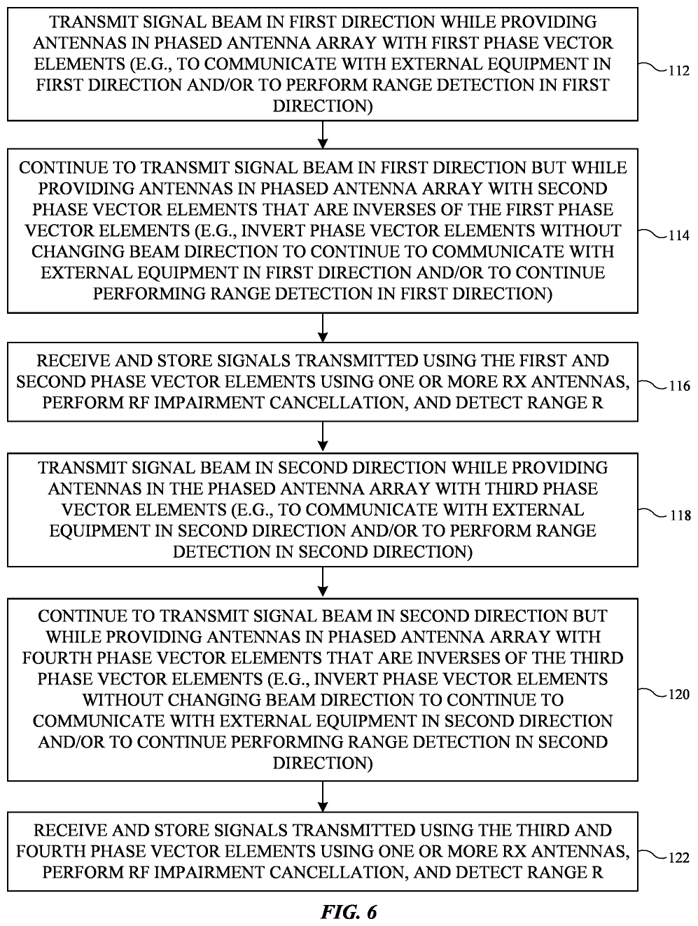

FIG. 6 is a flow chart of illustrative operations involved in controlling phased antenna array 110 to both perform signal beam steering and to perform range detection while mitigating on-chip leakage. At operation 112, real-time phase control circuit 82 may provide phase shifters 58 in phased antenna array 110 with first phase vector elements (e.g., elements of phase vector X) that configure/control phase shifters 58 to apply a first set of phase shifts to transmitted radio-frequency signals. The first set of phase shifts may configure the signal beam produced by phased antenna array 110 to point in a first direction (e.g., towards point A of FIG. 5). The first direction may be the direction of external communications equipment (e.g., another device 10, a wireless base station, a wireless access point, etc.) as one example. In this example, the signal beam may be used to convey wireless communications data with the external communications equipment. In another example, the first direction may be a direction in which control circuitry 14 intends to perform range detection operations (e.g., without conveying wireless communications data).

At operation 114, phased antenna array 110 may continue to transmit radio-frequency signals. However, real-time phase control circuit 82 may provide phase shifters 58 in phased antenna array 110 with second phase vector elements that are inverses of the first phase vector elements. The second phase vector elements may control/configure phase shifters 58 to apply a second set of phase shifts to the transmitted radio-frequency signals. Each phase shift in the second set of phase shifts may be 180 degrees out-of-phase with respect to the corresponding phase shift in the first set of phase shifts. This rotation in phase shift across phased antenna array 110 does not change the relative phases between each of the transmit antennas 30TX in phased antenna array 110, thereby allowing phased antenna array 110 to continue transmitting the radio-frequency signals in the same first direction as when controlled using the first phase vector elements. At the same time, since the second set of phases are 180 degrees out-of-phase with respect to the first set of phases, the radio-frequency signals transmitted using the first and second phase vector elements may be used to perform range detection in the first direction while mitigating the effects of on-chip leakage or other RF impairments.

At operation 116, one or more receive antennas 30RX and receive paths 44 (FIG. 2) may receive reflected signals 50 corresponding to the radio-frequency signals transmitted at operations 112 and 114 (e.g., some or all of operation 116 may be performed concurrently with operations 112 and 114). RF impairment canceller 78 may subtract the signals received using the receive path(s) while phased antenna array 110 transmitted radio-frequency signals using the second phase vector elements from the signals received using the receive path(s) while phased antenna array 110 transmitted radio-frequency signals using the first vector elements, retrieving the SOI without the effects of on-chip leakage (e.g., as when processing operation 98 of FIG. 3). Range detector 80 may detect range R using the retrieved SOL

At operation 118, real-time phase control circuit 82 may provide phase shifters 58 in phased antenna array 110 with third phase vector elements that configure/control phase shifters 58 to apply a third set of phase shifts to the transmitted radio-frequency signals. The third set of phase shifts (e.g., changing the relative phase between the antennas when compared to the first and second sets of phase shifts) may configure the signal beam produced by phased antenna array 110 to point in a second direction (e.g., towards point B of FIG. 5). The second direction may be the direction of external communications equipment (e.g., another device 10, a wireless base station, a wireless access point, etc.) as one example. In this example, the signal beam may be used to convey wireless communications data with the external communications equipment. In another example, the second direction may be a direction in which control circuitry 14 intends to perform range detection operations (e.g., without conveying wireless communications data).

At operation 120, phased antenna array 110 may continue to transmit radio-frequency signals. However, real-time phase control circuit 82 may provide phase shifters 58 in phased antenna array 110 with fourth phase vector elements that are inverses of the third phase vector elements. The fourth phase vector elements may control/configure phase shifters 58 to apply a fourth set of phase shifts to the transmitted radio-frequency signals. Each phase shift in the fourth set of phase shifts may be 180 degrees out-of-phase with respect to the corresponding phase shift in the third set of phase shifts. This rotation in phase shift across phased antenna array 110 does not change the relative phases between each of the transmit antennas 30TX in phased antenna array 110, thereby allowing phased antenna array 110 to continue transmitting the radio-frequency signals in the same second direction as when controlled using the third phase vector elements. At the same time, since the fourth set of phases are 180 degrees out-of-phase with respect to the first set of phases, the radio-frequency signals transmitted using the third and fourth phase vector elements may be used to perform range detection in the second direction while mitigating the effects of on-chip leakage or other RF impairments.

At operation 122, one or more receive antennas 30RX and receive paths 44 (FIG. 2) may receive reflected signals 50 corresponding to the radio-frequency signals transmitted at operations 118 and 120 (e.g., some or all of operation 122 may be performed concurrently with operations 118 and 120). RF impairment canceller 78 may subtract the signals received using the receive path(s) while phased antenna array 110 transmitted radio-frequency signals using the fourth phase vector elements from the signals received using the receive path(s) while phased antenna array 110 transmitted radio-frequency signals using the third vector elements to retrieve the SOI without the effects of on-chip leakage (e.g., as when processing operation 98 of FIG. 3). Range detector 80 may detect range R using the retrieved SOI. Processing may loop back to operation 112 as phased antenna array 110 changes the direction of its signal beam over time.

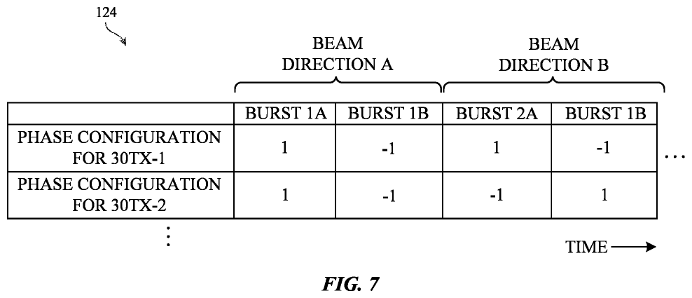

FIG. 7 includes a table 124 showing illustrative phase configurations for two transmit antennas 30TX-1 and 30TX-2 in phased antenna array 110 while processing the operations of FIG. 6. While table 124 illustrates settings for two transmit antennas 30TX, phased antenna array 110 may include any desired number of antennas.

The first row of table 124 shows phase configurations (e.g., phase vector elements from phase vector X such as phase vector element X1 of FIG. 5) that may be provided to the phase shifter 58-1 coupled to transmit antenna 30TX-1 in different sequential time periods. The second row of table 124 shows phase configurations that may be provided to the phase shifter 58-2 coupled to transmit antenna 30TX-2 (e.g., phase vector elements from phase vector X such as phase vector element X2 of FIG. 5) in the sequential time periods. The sequential time periods may include, for example, a period during which a first portion of a first signal burst (labeled as burst 1A) is transmitted by phased antenna array 110, immediately followed by a period during which a second portion of the first signal burst (labeled as burst 1B) is transmitted by phased antenna array 110, immediately followed by a period during which a first portion of a second signal burst (labeled as burst 2A) is transmitted by phased antenna array 110, and immediately followed by a period in which a second portion of the second signal burst (labeled as burst 2A) is transmitted by phased antenna array 110. The signal bursts may include bursts of chirp signals, bursts of other range detection signals, or bursts of wireless communications data used for communicating with external communications equipment.

As shown by table 124, phase shifter 58-1 of transmit antenna 30TX-1 may be controlled using a phase vector element X1=+1 and phase shifter 58-1 of transmit antenna 30TX-2 may be controlled using a phase vector element X2=+1 during transmission of burst 1A. The relative phases between the transmit antennas may configure phased antenna array 110 to transmit burst 1A within a signal beam oriented in beam direction A. During transmission of burst 1B, phase shifter 58-1 may then be controlled using a phase vector element X1=−1 (e.g., the inverse of the phase vector element used to transmit burst 1A) while phase shifter 58-2 is controlled using phase vector element X2=−1 (e.g., the inverse of the phase vector element used to transmit burst 1A). The relative phases between the transmit antennas remains the same for transmission of burst 1B as for transmission of burst 1A, allowing phased antenna array 110 to transmit burst 1B within the same signal beam oriented in beam direction A (e.g., without shifting the signal beam to other orientations between transmission of bursts 1A and 1B). In scenarios where phased antenna array 110 is only used for conveying wireless communications data, inverting the phase vector elements between burst 1A and 1B would introduce unnecessary cost and complexity to the system and would be redundant because it does not change the direction of the signal beam. Such systems would therefore transmit bursts 1A and 1B using the same phase vector elements across phased antenna array 110. However, inverting the phase vector elements between burst 1A and 1B allows RF impairment canceller 78 to retrieve the SOI from reflected signals 50 (FIG. 2) in beam direction A without on-chip leakage or other RF impairments (e.g., at operation 116 of FIG. 6).

Subsequently, during transmission of burst 2A, phase shifter 58-1 may be controlled using a phase vector element X1=+1 and phase shifter 58-1 of transmit antenna 30TX-2 may be controlled using a phase vector element X2=−1 (for example). The relative phases between the transmit antennas has changed between bursts 1B and 2A, configuring phased antenna array 110 to instead transmit burst 2B within a signal beam oriented in a different beam direction B. During transmission of burst 2B, phase shifter 58-1 may then be controlled using a phase vector element X1=−1 (e.g., the inverse of the phase vector element used to transmit burst 2A) while phase shifter 58-2 is controlled using phase vector element X2=+1 (e.g., the inverse of the phase vector element used to transmit burst 2A). The relative phases between the transmit antennas remains the same for transmission of burst 2B as for transmission of burst 2A, allowing phased antenna array 110 to transmit burst 2B within the same signal beam oriented in beam direction B (e.g., without shifting the signal beam to other orientations between transmission of bursts 2A and 2B). In scenarios where phased antenna array 110 is only used for conveying wireless communications data, inverting the phase vector elements between burst 2A and 2B would introduce unnecessary cost and complexity to the system and would be redundant because it does not change the direction of the signal beam. Such systems would therefore transmit bursts 2A and 2B using the same phase vector elements across phased antenna array 110. However, inverting the phase vector elements between burst 2A and 2B allows RF impairment canceller 78 to retrieve the SOI from reflected signals 50 (FIG. 2) in beam direction B without on-chip leakage or other RF impairments (e.g., at operation 116 of FIG. 6). This process may be repeated over time across phased antenna array 110 to perform beam steering and on-chip leakage-mitigated range detection. The phase vector elements may, in general, be complex numbers having any desired values.

The description used herein of phase shifts that are “180 degrees out-of-phase” with respect to each other (e.g., the phase shifts applied by phase shifter 58 in its first and second states) does not mean that the phase shifts are exactly 180 degrees out-of-phase with respect to each other. A second phase or phase shift that is referred to herein as being 180 degrees out-of-phase with respect to a first phase or phase shift (e.g., as applied between operations 90 and 94 of FIG. 3 or between operations 112/114 and between operations 118/120 of FIG. 6) also includes phases or phase shifts that are not exactly 180 degrees out-of-phase with respect to the first phase or phase shift due to circuit imperfections or other practical effects (e.g., the phase rotations described herein may differ slightly from 180 degrees due to unwanted circuit effects, thermal effects, etc.). If desired, the second phases or phase shifts as described herein (e.g., the phase shifts produced by the phase vector element(s) applied at operation 94 of FIG. 3, operation 114 of FIG. 6, and/or operation 120 of FIG. 6) may instead be 170-190 degrees out-of-phase with respect to the first phases or phase shifts as described herein (e.g., the phase shifts produced by the phase vector element(s) applied at operation 90 of FIG. 3, operation 112 of FIG. 6, and/or operation 118 of FIG. 6), 160-200 degrees out-of-phase with respect to the first phases or phase shifts as described herein, 90-270 degrees out-of-phase with respect to the first phases or phase shifts as described herein, 175-185 degrees out-of-phase with respect to the first phases or phase shifts as described herein, or other phase rotations that are approximately equal to 180 degrees. These non-180-degree phase rotations may reduce the effects of on-chip leakage less than the case where the phase rotation is 180 degrees but such a reduction may still improve the accuracy with which range R is determined (e.g., a perfect 180 degree rotation/difference may produce a 0.0 dB link budget penalty, a 22.5 degree phase error may produce a −0.2 dB link budget penalty, a 30 degree phase error may produce a −0.3 dB link budget penalty, a 45 degree phase error may produce a −0.7 dB link budget penalty, a 90 degree phase error may produce a −3.0 dB link budget penalty, etc.).

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-9 (e.g., the operations of FIGS. 3 and 6) may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 18 of FIG. 1, etc.). The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. An electronic device comprising:
a first antenna coupled to a transmit path and configured to transmit a radio-frequency signal;
a second antenna coupled to a receive path;
a phase shifter disposed on the transmit path or the receive path, the phase shifter having a first state in which the phase shifter applies a first phase shift during transmission of the radio-frequency signal by the first antenna and having a second state in which the phase shifter applies a second phase shift to during transmission of the radio-frequency signal by the first antenna, the second phase shift being different from the first phase shift; and
one or more processors configured to
receive, via the second antenna, a first reflected signal while the phase shifter is in the first state,
receive, via the second antenna, a second reflected signal while the phase shifter is in the second state, and
detect a range between the electronic device and an external object based on the first reflected signal and the second reflected signal.

2. The electronic device of claim 1, wherein the one or more processors is configured to recover a signal-of-interest by generating a difference value between the second reflected signal and the first reflected signal.

3. The electronic device of claim 2, wherein the one or more processors is configured to detect the range based on the recovered signal-of-interest.

4. The electronic device of claim 1, wherein the second phase shift is 90-270 degrees out-of-phase with respect to the first phase shift.

5. The electronic device of claim 1, further comprising:
a control circuit configured to provide a first phase vector element to the phase shifter that places the phase shifter in the first state and configured to provide a second phase vector element to the phase shifter that places the phase shifter in the second state.

6. The electronic device of claim 5, wherein the second phase vector element is an inverse of the first phase vector element.

7. The electronic device of claim 1, wherein the radio-frequency signal comprises a chirp signal.

8. The electronic device of claim 7, further comprising:
a de-chirp path that couples the transmit path to the receive path.

9. The electronic device of claim 1, further comprising:
a phased antenna array that includes the first antenna, the phased antenna array being configured to generate a signal beam in a pointing direction, the one or more processors being configured to change the phase shifter from the first state to the second state without changing the pointing direction of the signal beam.

10. A method of operating an electronic device, the method comprising:
with a first antenna, transmitting a first signal burst with a first phase shift;
with a second antenna, receiving first reflected signals corresponding to the first signal burst with the first phase shift;
with the first antenna, subsequent to transmission of the first signal burst, transmitting a second signal burst with a second phase shift that is different from the first phase shift;
with the second antenna, receiving second reflected signals corresponding to the second signal burst with the second phase shift; and
with one or more processors, detecting a range to an external object based on the first reflected signals and the second reflected signals.

11. The method of claim 10, further comprising:
with mixer circuitry, downconverting the first reflected signals to produce first baseband signals; and
with the mixer circuitry, downconverting the second reflected signals to produce second baseband signals, wherein detecting the range comprises detecting the range based on the first baseband signals and the second baseband signals.

12. The method of claim 11, wherein detecting the range further comprises:
subtracting the second baseband signals from the first baseband signals to retrieve a signal-of-interest; and
detecting the range based on the signal-of-interest.

13. The method of claim 11, wherein the first signal burst comprises a first chirp signal and the second signal burst comprises a second chirp signal, the method further comprising:
with the mixer circuitry, mixing the first chirp signal with the first reflected signals; and
with the mixer circuitry, mixing the second chirp signal with the second reflected signals.

14. The method of claim 10, wherein the electronic device comprises a phased antenna array that includes the first antenna, the method further comprising:
with the phased antenna array, transmitting a signal beam in a beam pointing direction, wherein transmitting the signal beam comprises transmitting the first signal burst in the beam pointing direction and transmitting the second signal burst in the beam pointing direction.

15. The method of claim 10, wherein the second phase shift is 90-270 degrees out-of-phase with respect to the first phase shift

16. A method of operating wireless circuitry having a phase shifter communicably coupled to a transmit antenna and having a receive antenna, the method comprising:
with the transmit antenna, transmitting a first radio-frequency signal while the phase shifter is configured using a first phase vector element;
with the receive antenna, receiving a second radio-frequency signal while the transmit antenna transmits the first radio-frequency signal;
with the transmit antenna, transmitting a third radio-frequency signal while the phase shifter is configured using a second phase vector element that is an inverse of the first phase vector element;
with the receive antenna, receiving a fourth radio-frequency signal while the transmit antenna transmits the third radio-frequency signal; and
with the one or more processors, detecting a range between the wireless circuitry and an external object based on the second radio-frequency signals and the fourth radio-frequency signals received by the receive antenna.

17. The method of claim 16, wherein the first phase vector element configures the phase shifter to apply a first phase shift to the first radio-frequency signal and wherein the second phase vector element configures the phase shifter to apply a second phase shift to the third radio-frequency signal that is 180 degrees out-of-phase with respect to the first phase shift.

18. The method of claim 16, wherein the wireless circuitry comprises a phased antenna array having a set of transmit antennas that includes the transmit antenna and having a set of phase shifters that include the phase shifter, the method further comprising:
with the phased antenna array, transmitting a signal beam that includes the first radio-frequency signal in a first beam pointing direction while the set of phase shifters is configured using the first phase vector.

19. The method of claim 18, further comprising:
with the phased antenna array, transmitting the signal beam in the first beam pointing direction while the set of phase shifters is configured using the second phase vector, the signal beam including the third radio-frequency signal.

20. The method of claim 19, further comprising:
with the phased antenna array, transmitting the signal beam in a second beam pointing direction that is different from the first beam pointing direction while the set of phase shifters is configured using a third phase vector.
